(19) United States
(12) Patent Application Publication
(10) Pub. No.: US 2009/0154787 A1
(43) Pub. Date: Jun. 18, 2009

(54) IMAGE RECONSTRUCTION DEVICE AND METHOD

(75) Inventors: Matthias Bertram, Koln (DE); Til Aach, Lubeck (DE); Georg Hans Rose, Magdeburg (DE); Dirk Schaefer, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,554

(22) PCT Filed: Nov. 22, 2005
(86) PCT No.: PCT/IB05/53861

§ 371 Date: May 17, 2007

(30) Foreign Application Priority Data
Nov. 23, 2004 (EP) 04106006.2

(51) Int. Cl. G06K 9/00

(52) U.S. Cl. 382/132

(57) ABSTRACT

The present invention relates to an image reconstruction device and a corresponding method for reconstructing a 3D image of an object (7) from projection data of said object (7). In order to obtain 3D images having sharp high-contrast structures and almost no image blur, and in which streak artifacts (and noise in tissue-like regions) are strongly reduced, an image reconstruction device is proposed comprising: a first reconstruction unit (30) for reconstructing a first 3D image of said object (7) using the original projection data, an interpolation unit (31) for calculating interpolated projection data from said original projection data, —a second reconstruction unit (32) for reconstructing a second 3D image of said object (7) using at least the interpolated projection data, a segmentation unit (33) for segmentation of the first or second 3D image into high-contrast and low-contrast areas, a third reconstruction unit (34) for reconstructing a third 3D image from selected areas of said first and said second 3D image, wherein said segmented 3D image is used to select image values from said first 3D image for high-contrast areas and image values from said second 3D image for low-contrast areas.

The present invention relates to an image reconstruction device and a corresponding image reconstruction method for reconstructing a 3D image of an object from projection data of said object. Further, the present invention relates to an imaging system for 3D imaging of an object and to a computer program for implementing said image reconstruction method on a computer.

C-arm based rotational X-ray volume imaging is a method of high potential for interventional as well as diagnostic medical applications. While current applications of this technique are restricted to reconstruction of high contrast objects such as vessels selectively filled with contrast agent, the extension to soft contrast imaging would be highly desirable. However, as a drawback, due to the relatively slow rotational movement of the C-arm and the limited frame rate of current X-ray detectors, typical sweeps for acquiring projection series for 3D reconstruction provide only a small number of projections as compared to typical CT acquisition protocols. This angular under-sampling leads to significant streak artefacts in the reconstructed volume causing degradation of the resulting 3D image quality, especially if filtered backprojection is used for image reconstruction.

In the article of M. Bertram, G. Rose, D. Schafer, J. Wiegert, T. Aach, “Directional interpolation of sparsely sampled cone-beam CT sinogram data”, Proceedings 2004 IEEE International Symposium on Biomedical Imaging (ISBI), Arlington, Va., Apr. 15-18, 2004 a strategy has been described to efficiently reduce streak artefacts originating from sparse angular sampling. The underlying idea is that the number of projections available for reconstruction can be increased by means of nonlinear, directional interpolation in sinogram space. As a drawback, however, additionally interpolated projections show a certain image blur. The technique of directional interpolation described in this article was developed to minimize said image blur, but a small, inevitable amount of blurring still remains.

It is an object of the present invention to provide an image reconstruction device and a corresponding image reconstruction method for reconstructing a 3D image of an object from projection data of said object by which the problem of remaining image blur is overcome.

This object is achieved according to the present invention by an image reconstruction device as claimed in claim 1 comprising:

a first reconstruction unit for reconstructing a first 3D image of said object using the original projection data,

an interpolation unit for calculating interpolated projection data from said original projection data,

a second reconstruction unit for reconstructing a second 3D image of said object using least at the interpolated projection data,

a segmentation unit for segmentation of the first or second 3D image into high-contrast and low-contrast areas,

a third reconstruction unit for reconstructing a third 3D image from selected areas of said first and said second 3D image, wherein said segmented 3D image is used to select image values from said first 3D image for high-contrast areas and image values from said second 3D image for low-contrast areas.

A corresponding image reconstruction method is claimed in claim 11. A computer program for implementing said method on a computer is claimed in claim 12.

The invention relates also to an imaging system for 3D imaging of an object as claimed in claim 9 comprising:

an acquisition unit for acquisition of projection data of said object,

a storage unit for storing said projection data,

an image reconstruction device for reconstructing a 3D image of said object as claimed in any one of claims 1 to 8, and

a display for display of said 3D image.

Preferred embodiments of the invention are described in the dependent claims.

The invention is based on the idea to apply a hybrid approach for 3D image reconstruction. Two intermediate reconstructions are performed, one utilizing only originally measured projections, and another one that in addition utilizes interpolated projections. The final reconstructed 3D image, that shall be displayed and used by the physician, is comprised of the two intermediate reconstructions. This is done in such a way that the advantages of the two intermediate reconstructions are combined.

In particular, for the final reconstructed hybrid volume 3D image, the result of the interpolated reconstruction is used for the low-contrast (‘tissue’) voxels while the result of the original reconstruction is used for the high-contrast voxels. This allows efficient reduction of streak artefacts in homogeneous regions of the reconstructed 3D image, while blurring of the boundaries of high-contrast objects such as bones or vessels filled with contrast agent is prevented, such that the spatial resolution of such objects is completely preserved.

In principle, the idea of this hybrid approach is independent of the interpolation scheme used for creation of the additional projections, but the use of an accurate non-linear interpolation, such as the approach described in the above mention article of M. Bertram et al., is expected to produce optimal results.

In a preferred embodiment of the invention the second reconstruction unit is adapted for reconstructing a preliminary second 3D image of said object using only the interpolated projection data and for adding said first 3D image to said preliminary second 3D image to obtain said second 3D image. This saves computation time compared to the alternative embodiment according to which the interpolated projection data and the original projection data are both directly used in the reconstruction directly for reconstructing the second 3D image. The result is in both cases the same since the reconstruction is a linear operation.

In a further embodiment only the interpolated projection data are used in the reconstruction of the second 3D image which is even less computation time consuming, but is less accurate.

Generally, for segmentation of the first or second 3D image into high-contrast and low-contrast areas any kind of segmentation method can be applied. Preferably, an edge-based segmentation method or a gray-value based segmentation method is applied. For instance, in the latter method those voxels with gray value gradients above a certain threshold are segmented. Generally and independently of the particular segmentation method applied voxels located near the boundaries of high-contrast objects, such as bones or vessels filled with contrast agent, shall be determined, where most of the blurring occurs in the second 3D image, i.e. in the interpolated reconstruction. For gradient-based segmentation, the absolute value of the gray value gradient is computed for each voxel. Then, those voxels with gray value gradients above a certain threshold are segmented. All voxels segmented in either one, or in both of the two segmentation steps (the gray-value threshold based segmentation step or the gradient-based segmentation step) are selected to represent the final segmentation result.

In order to further improve the quality and appropriateness of the segmentation it is proposed in another embodiment of the invention that the segmented boundaries of high-contrast objects are broadened by means of an image dilatation method, for instance a standard dilatation method, to ensure that the segmentation contains all potentially blurred voxels. Dilatation may be performed by adding all voxels to the segmentation result that have at least one segmented voxel in their close neighborhood.

In a still further embodiment of the invention it is proposed to remove singular segmented high-contrast areas from said high-contrast areas by use of an image erosion method after said segmentation. Thus, singular voxels not belonging to high-contrast objects or their boundaries, which may have been unintentionally segmented, can be removed from the segmentation result. Erosion may be performed by excluding all voxels from the segmentation result that do not have any other segmented voxel in their close neighborhood.

The image reconstruction method proposed according to the present invention can be applied in an imaging system for 3D imaging of an object as claimed in claim 8. For acquisition of projection data of the object, preferably a C-arm base X-ray volume imaging unit or a CT imaging unit is used. The described type of streak artifacts occurs not only for X-ray volume imaging modalities, but also for other imaging modalities, such as CT or tomosynthesis, particularly as long as a filtered back-projection type algorithm is used for reconstruction. Generally, in CT the problem is less relevant than in X-ray volume imaging due to the usually high number of acquired projections. There are, however, specific CT applications such as triggered or gated coronary reconstructions, where the problem of streak artifacts is significant and where the invention can advantageously be applied.

The invention will now be explained in more detail with reference to the drawings in which

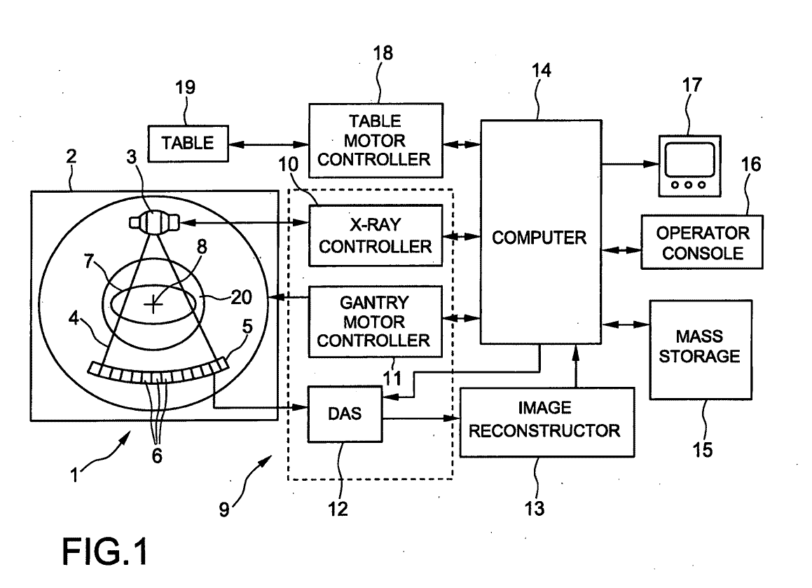

FIG. 1 shows a block diagram of an imaging system according to the invention,

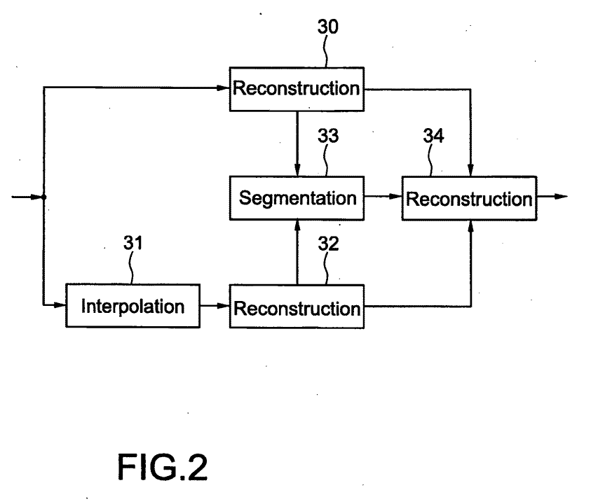

FIG. 2 shows a block diagram of an image reconstruction device according to the present invention,

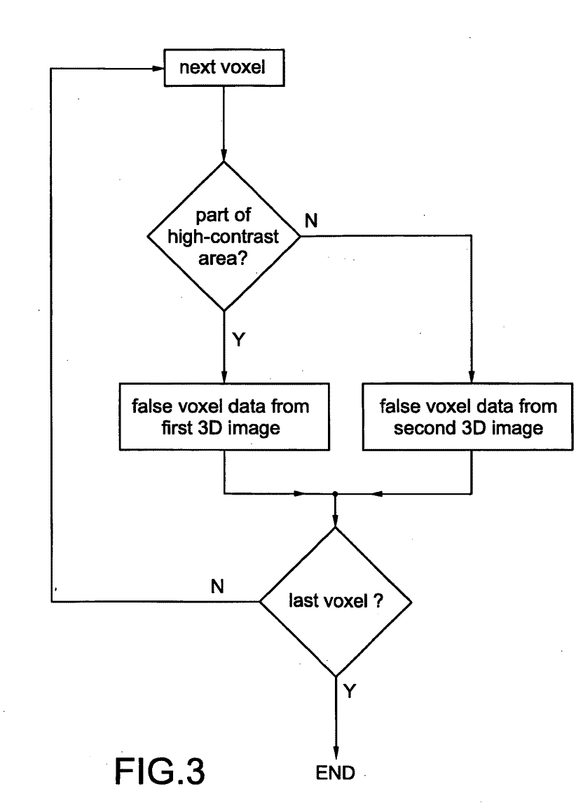

FIG. 3 shows a flow chart of the third reconstruction step for reconstructing the final 3D image,

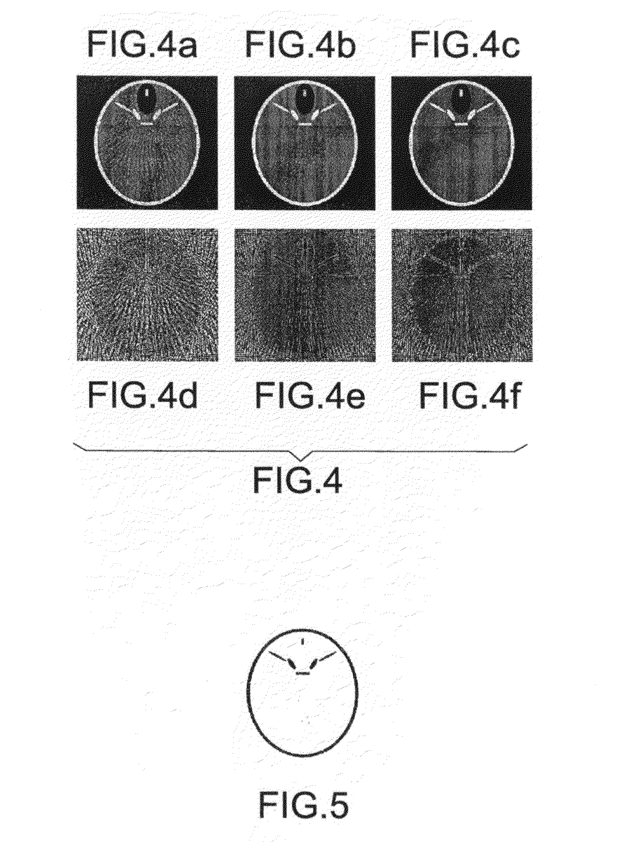

FIG. 4 shows reconstructed images of a mathematical head phantom and corresponding error images obtained with known methods and with the method according to the present invention, and

FIG. 5 shows the segmentation result for the first reconstruction shown in FIG. 4a.

FIG. 1 shows a computed tomography (CT) imaging system 1 according to the present invention including a gantry 2 representative of a CT scanner. Gantry 2 has an X-ray source 3 that projects a beam of X-rays 4 toward a detector array 5 on the opposite side of gantry 2. Detector array 5 is formed by detector elements 6 which together sense the projected X-rays that pass through an object 7, for example a medical patient. Detector array 5 is fabricated in a multislice configuration having multiple parallel rows (only one row of detector elements 6 is shown in FIG. 1) of detector elements 6. Each detector element 6 produces an electrical signal that represents the intensity of an impinging X-ray beam and hence the attenuation of the beam as it passes through patient 7. During a scan to acquire X-ray projection data, in particular 2D projection data or 3D sinogram data, gantry 2 and the components mounted thereon rotate about a center of rotation 8.

Rotation of gantry 2 and the operation of X-ray source 3 are governed by a control mechanism 9 of CT system 1. Control mechanism 9 includes an X-ray controller 10 that provides power and timing signals to X-ray source 3 and a gantry motor controller 11 that controls the rotational speed and position of gantry 2. A data acquisition system (DAS) 12 in control mechanism 9 samples analog data from detector elements 6 and converts the data to digital signals for subsequent processing. An image reconstructor 13 receives sampled and digitized X-ray data from DAS 12 and performs high speed image reconstruction. The reconstructed image is applied as an input to a computer 14 which stores the image in a mass storage device 15.

Computer 14 also receives commands and scanning parameters from an operator via console 16 that has a keyboard. An associated cathode ray tube display 17 allows the operator to observe the reconstructed image and other data from computer 14. The operator supplied commands and parameters are used by computer 14 to provide control signals and information to DAS 12, X-ray controller 10 and gantry motor controller 11. In addition, computer 14 operates a table motor controller 18 which controls a motorized table 19 to position patient 7 in gantry 2. Particularly, table 19 moves portions of patient 7 through gantry opening 20.

Details of the image reconstructor 13 as proposed according to the present invention are shown in the block diagram of FIG. 2.

First, using the measured projection data, a 3D image reconstruction is performed as usual in a first reconstruction unit 30. Hereinafter, this reconstruction is referred to as ‘original reconstruction’ (or ‘first 3D image’). In this reconstruction, the objects have quite sharp boundaries, as determined by the modulation transfer function of the imaging system. In case of sparse angular sampling, however, the original reconstruction suffers from the presence of characteristic streak artefacts originating from the sharp object boundaries in each utilized projection. This can, for instance, be seen in the reconstruction of a simulated head phantom shown in FIG. 4a.

In a second step, an appropriate interpolation scheme is used by an interpolation unit 31 to increase the angular sampling density of the available projections. For instance, the number of projections may be doubled, such that in between two originally measured projections, an additional projection is interpolated at an intermediate projection angle. Any type of interpolation algorithm may be utilized for this step, though accurate non-linear interpolation is preferred.

A second 3D image, hereinafter referred to as ‘interpolated reconstruction’, is then reconstructed from both the originally measured and the newly interpolated projection data by a second reconstruction unit 32. In practice, computation time is saved by reconstructing a preliminary second image from the interpolated projections only, and by adding the original reconstruction to this image which gives the same result (the second 3D image) because reconstruction is a linear operation. Due to the larger angular sampling density, the intensity of streak artefacts in the interpolated reconstruction is strongly reduced. Also, due to the low-pass filtering effect inherent to interpolation, the noise level in the interpolated reconstruction is reduced. However, the reductions of streak artefacts and noise are accompanied by the occurrence of a certain amount of image blur in the interpolated reconstruction. This can, for instance, be seen in the reconstruction of a simulated head phantom shown in FIG. 4b.

In a third step a segmentation is applied to either the original or the interpolated reconstruction by a segmentation unit 33. The aim of segmentation is to determine the voxels located near the boundaries of high-contrast objects (such as bones or vessels filled with contrast agent), where most of the blurring occurs in the interpolated reconstruction. For this purpose, the absolute value of the gray value gradient is computed for each voxel. Then, those voxels with gray value gradients above a certain threshold are segmented. Alternatively, more sophisticated edge-based segmentation methods may be used. The segmented boundaries of high-contrast objects are then preferably broadened by means of standard image dilatation techniques to ensure that the segmentation contains all potentially blurred voxels.

When high-contrast voxels occupy only a relatively small fraction of the image, this can be further ensured by adding all voxels with gray values outside a certain ‘soft-tissue-like’ gray value window to the segmentation result. On the other hand, singular voxels not belonging to high-contrast objects or their boundaries, which may have been unintentionally segmented because of image noise or streak artefacts, may be removed from the segmentation result by means of standard image erosion techniques. As an example, FIG. 5 shows the result of a simple (gray value and gradient based) threshold segmentation of a reconstructed head phantom.

In a fourth step, the segmentation result is used by a third reconstruction unit 34 to assemble the hybrid reconstruction, i.e. the desired final 3D image, from the original and the interpolated reconstructions. Within this process, the result of the original reconstruction is used for the segmented ‘high-contrast’ voxels while the result of the interpolated reconstruction is used for the remaining ‘soft-tissue-like’ voxels. As a result, the hybrid reconstruction contains sharp high-contrast structures and almost no image blur, and in addition, the streak artefacts and noise are strongly reduced in tissue-like regions. This can, for instance, be seen in the reconstruction of a simulated head phantom shown in FIG. 4c.

The last step of reconstructing the final 3D image is in more details illustrated in the flow chart of FIG. 3. In this step no completely new reconstruction is carried out, but portions of the original and interpolated reconstructions are combined. Specifically, for each voxel the segmentation result obtained by the segmentation unit 33 determines from which one of these two reconstructions the respective gray value is taken.

In step S1 a particular voxel of the final 3D image is treated. It is then chosen in step S2 if this voxel is part of a high-contrast area or not which can be determined based on the segmentation result. If this voxel is part of a high-contrast area then in step S3 the voxel data, in particular the gray value, is taken from the first 3D image, while in the other case the voxel data, in particular the gray value, is taken from the second 3D image in step S4. This procedure is carried out iteratively until the last voxel of the 3D image has been reached which is checked in step S5.

As has already been mentioned FIGS. 4a to 4c show reconstructed images of a mathematical head phantom. FIGS. 4d to 4f show corresponding error images. The original reconstruction (FIG. 4a) is based on 90 projections taken over an angular range of 360 degree. The interpolated reconstruction (FIG. 4b) is based on these original 90 projections and additionally on 90 directionally interpolated projections. The hybrid reconstruction (FIG. 4c) as proposed according to the present invention is assembled partly from the original and partly from the interpolated reconstruction, combining their respective advantages. Thus FIGS. 4d-4f show difference images between the respective images above, FIGS. 4a-4c, and a reference reconstruction made from a large number of 2880 original projections, in order to emphasize the differences between images FIGS. 4a-4c.

FIG. 5 shows a segmentation result for the original reconstruction shown in FIG. 4a. For assembly of the hybrid reconstruction shown in FIG. 4c, gray values from the original reconstruction were used within the black regions, and values from the interpolated reconstruction were used elsewhere.

The basic idea of the preferred method of non-linear interpolation applied in the interpolation unit 31 shown in FIG. 2 is to use shape-based (i.e., directional) interpolation to predict the missing projections. Interpolated projections by means of this method provide additional information for reconstruction, enabling significant reduction of under-sampling caused image artifacts. Direction-driven interpolation methods work by estimating the orientation of edges and other local structures in a given set of input data. In case of rotational X-ray volume imaging, a three-dimensional set of projection data (3D sinogram) is obtained by stacking all the acquired two-dimensional projections. Purpose of interpolation is to increase the sampling density of this data set in direction of the rotation angle axis.

The procedure of interpolation is divided into two steps. First, the direction of local structures at each sample point in the 3D sinogram is estimated by means of gradient calculation, or, more appropriately, their orientation is determined by calculation of the structure tensor and its eigensystem. Second, for interpolation of a missing projection, only such pairs of pixels in the measured adjacent projections are considered that are oriented parallel to the previously identified local structures, rather than those oriented perpendicularly. In this way, undesired smoothing of sharp gray level changes in the interpolated projection data is prevented. In a practical application, all of the pixels in a neighborhood of the adjacent projections are considered for interpolation, but their contributions are weighted according to the local orientation.

The application of the proposed method in C-arm based X-ray volume imaging will enable significant reduction of image artefacts originating from sparse angular sampling while completely preserving spatial resolution of high-contrast objects. In this way, the method contributes towards overcoming the current restriction of C-arm based X-ray volume imaging to high contrast objects, a final goal which is supposed to open new areas of application for diagnosis as well as treatment guidance. The new hybrid reconstruction method can be added to existing 3D-RA reconstruction software packages. Further, the invention can advantageously applied in CT imaging systems.

As a result, the hybrid reconstruction as proposed according to the present invention contains sharp high-contrast structures and almost no image blur, and in addition, the streak artefacts (and noise in tissue-like regions) are strongly reduced.

1. Image reconstruction device for reconstructing a 3D image of an object (7) from projection data of said object (7), comprising:
a first reconstruction unit (30) for reconstructing a first 3D image of said object (7) using the original projection data,
an interpolation unit (31) for calculating interpolated projection data from said original projection data,
a second reconstruction unit (32) for reconstructing a second 3D image of said object (7) using at least the interpolated projection data,
a segmentation unit (33) for segmentation of the first or second 3D image into high-contrast and low-contrast areas,
a third reconstruction unit (34) for reconstructing a third 3D image from selected areas of said first and said second 3D image, wherein said segmented 3D image is used to select image values from said first 3D image for high-contrast areas and image values from said second 3D image for low-contrast areas.

2. Device as claimed in claim 1, wherein said second reconstruction unit (32) is adapted for reconstructing a preliminary second 3D image of said object using only the interpolated projection data and for adding said first 3D image to said preliminary second 3D image to obtain said second 3D image.

3. Device as claimed in claim 1, wherein said second reconstruction unit (32) is adapted for directly reconstructing said second 3D image of said object using the interpolated projection data and the original projection data in said reconstruction.

4. Device as claimed in claim 1, wherein said second reconstruction unit (32) is adapted for directly reconstructing said second 3D image of said object using only the interpolated projection data.

5. Device as claimed in claim 1, wherein said interpolation unit (31) is adapted for using a non-linear interpolation.

6. Device as claimed in claim 1, wherein said segmentation unit (33) is adapted for using an edge-based segmentation method or a gray-value based segmentation method.

7. Device as claimed in claim 1, wherein said segmentation unit (33) is adapted for broadening the segmented high-contrast areas, in particular by use of a dilatation method.

8. Device as claimed in claim 1, wherein said segmentation unit (33) is adapted for removing singular segmented high-contrast areas from said high-contrast areas by use of an image erosion method.

9. Imaging system for 3D imaging of an object comprising:
an acquisition unit (2) for acquisition of projection data of said object (7),
a storage unit (15) for storing said projection data,
an image reconstruction device (13) for reconstructing a 3D image of said object (7) as claimed in claim 1, and
a display (27) for display of said 3D image.

10. Imaging system as claimed in claim 9, wherein said acquisition unit (2) is a CT imaging unit or an X-ray volume imaging unit.

11. Image reconstruction method for reconstructing a 3D image of an object from projection data of said object (7), comprising the steps of:
reconstructing a first 3D image of said object (7) using the original projection data,
calculating interpolated projection data from said original projection data,
reconstructing a second 3D image of said object (7) using at least the interpolated projection data,
segmenting the first or second 3D image into high-contrast and low-contrast areas,
reconstructing a third 3D image from selected areas of said first and said second 3D image, wherein said segmented 3D image is used to select image values from said first 3D image for high-contrast areas and image values from said second 3D image for low-contrast areas.

12. Computer program comprising program code means for performing the steps of the method as claimed in claim 11 when said computer program is executed on a computer.
